(19) United States
(12) Patent Application Publication
(10) Pub. No.: US 2011/0119266 A1
(43) Pub. Date: May 19, 2011

(54) METHOD FOR DOCUMENTING AND VIEWING EXPERIENCES

(75) Inventors: Tami Zipora Ben-Zvi, Redmond, WA (US); Nir Ben-Zvi, Redmond, WA (US)

(73) Assignee: BTDT INTERNET TECHNOLOGIES LLC, Redmond, WA (US)

(21) Appl. No.: 12/618,708

(22) Filed: Nov. 14, 2009

(51) Int. Cl. G06F 17/30

(52) U.S. Cl. 707/736; 707/792; 707/E17.044

(57) ABSTRACT

A method for documenting and viewing human experiences is disclosed. The method may include enabling people to record experiences starting at a decision that needs to be taken (decision point) and providing the relevant data points for the decision followed by the action taken and the consequences. These consequences can then be further linked to a new experience. Further, this method may allow multiple people to enter their experiences for the same decision point creating a per decision point inclusive repository of the various data points, actions and consequences as experienced by multiple people. Last, the method may allow people to view the experiences entered by others applying keyword search criteria, tags and data point filters that fit their desired viewing parameters and to navigate between the experiences using the defined links between consequences and experiences

In another embodiment, a method for documenting and viewing human experiences may include providing a per person experience recording such that the system does not merge the experiences and data points of multiple people and may allow viewing these experiences based on similar criteria to the above

### BACKGROUND

It is universally known that when it comes to making decisions and taking actions, experience is priceless. Human experience is a valuable resource across all spans of life ranging from the business environment to the personal home environment. This is true when faced with critical issues as well as on a day to day basis.

A keen observer will also note the repetitive nature of human experiences. We live in environments where people go through very similar experiences making different choices with different consequences. This applies to people in the same physical neighborhood as well to people across the world.

For example: A new company executive managing an acquisition would benefit from knowing what his predecessors and peers did in the same situation and what were the consequences of their actions. Or, a parent of a teenager would appreciate to discover how other parents in similar circumstances to his own handled the child and what was successful.

In today's connected world, there is an opportunity to share human experiences by recording human experiences into a shared repository so that people can view what other people experiences so that they can make more informed decisions based on a global experience repository. People around the world should be able to record experiences that they would like to share with others while other people should be able to search through the experience repository to discover information on the relevant experiences for their situation

As noted above, it is probable that many people will go through similar experiences with different circumstances, different choices and different consequences. When other people search through the experience repository, it is important that they should be able to group and view all the similar experiences so that they can get a better picture of the different aspects of the same experience as reflected across the different individuals that logged their experiences

Thus, there is a need for a method to document and record human experiences such that it can be joined into a structured repository in a manner that enables having a thorough recording of these experiences and such that discovering similar groups of experiences can be achieved.

### SUMMARY

A method for documenting and viewing human experiences may include enabling people to record experiences starting at a decision that needs to be taken (decision point) and providing the relevant data points for the decision followed by the action taken and the consequences. These consequences can then be further linked to a new experience.

A method for documenting experiences may further include allowing multiple people to enter their experiences for a decision point creating a per decision point inclusive repository of the various experiences, data points, actions and consequences as experienced by multiple people.

A method for viewing recorded experiences may allow people to view the experiences recorded by other people. Further, people can apply keyword search criteria, tags and data point filters that fit their desired viewing parameters and navigate between the experiences using the defined links between consequences and experiences

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION

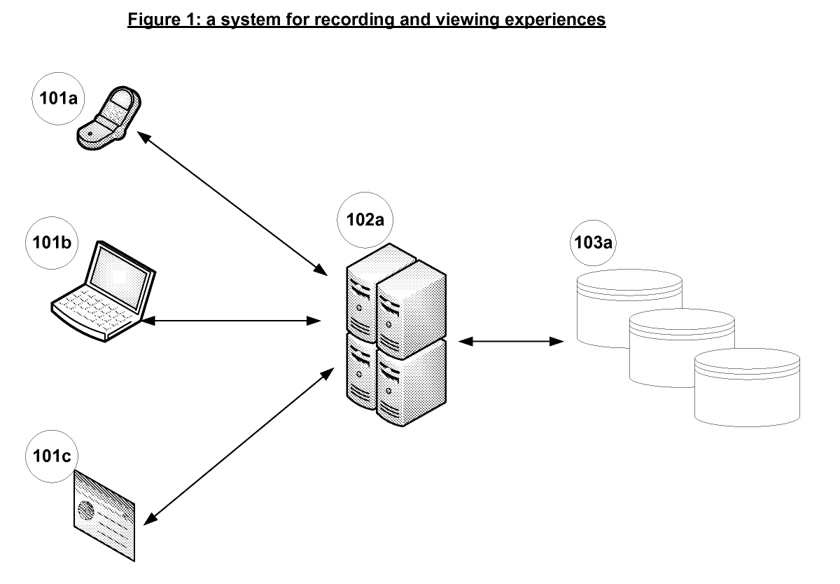

FIG. 1 depicts a system for recording and viewing experiences;

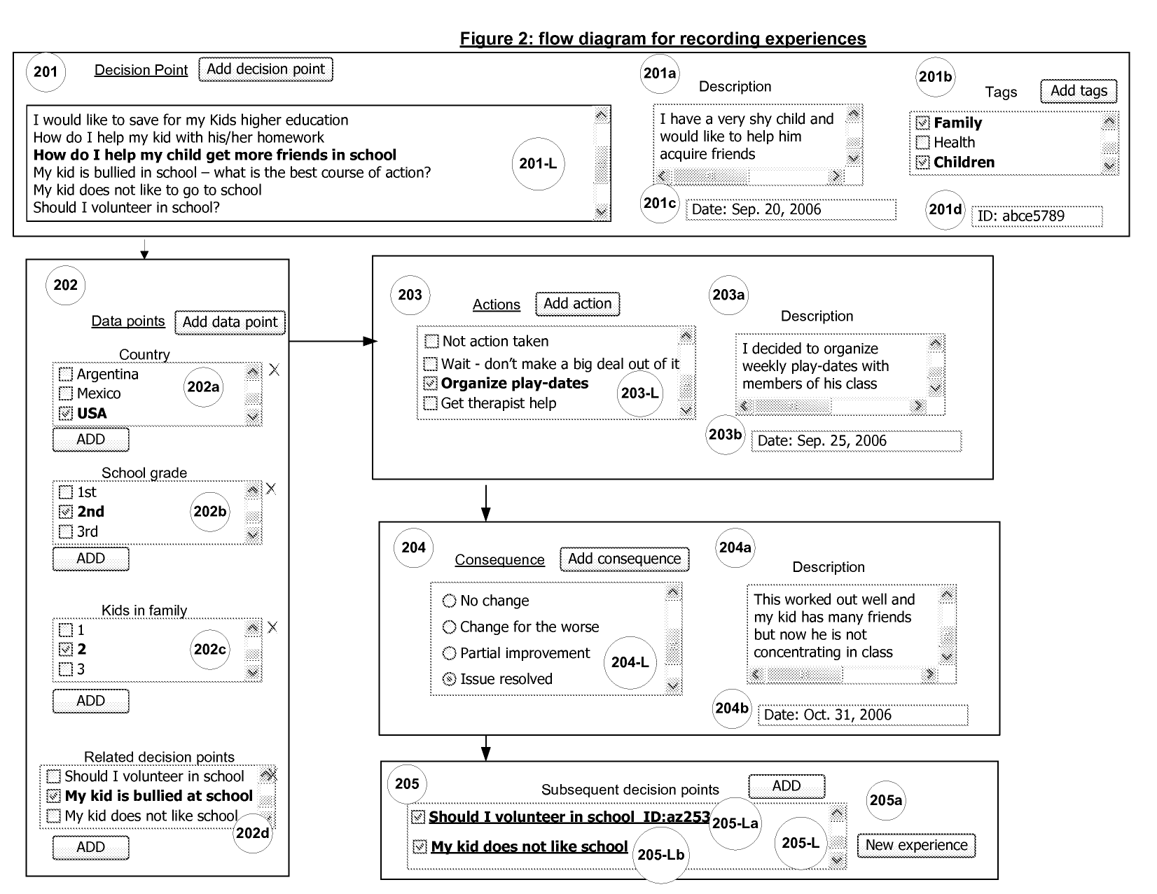

FIG. 2 depicts a flow diagram for recording experiences;

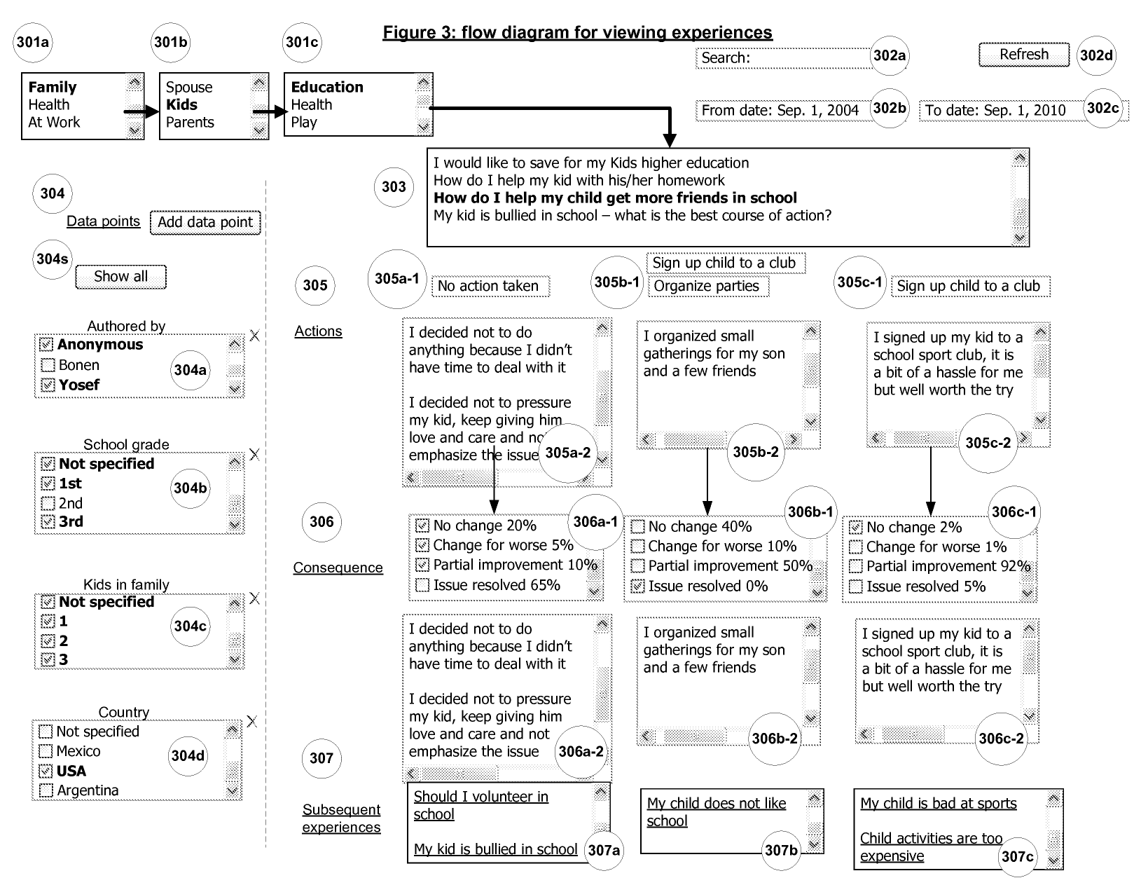

FIG. 3 depicts a flow diagram for viewing experiences;

### DETAILED DESCRIPTION

FIG. 1 depicts an exemplary system for recording and viewing a human experience. The system includes an example of various user interface points 101a-101c that are used to enter and view experiences, one or more application servers 102a to control access to and storage of the experience information and one or more databases 103a used to store and index the experience information. The databases 103a, servers 102a and interfaces 101a-101c may reside in the same location or in different locations.

People may record their experiences through a web interface 101c or through an application interface running on their local computer 101b or mobile device 101a. The recorded experiences will then be transmitted to the application servers 102a to be stored in a database 103a that contains experiences that were entered by multiple people. These experiences can then be correlated, searched and viewed

FIG. 2 depicts an exemplary flow for recording a human experience. The flow is composed of a decision point 201 and the various data points 202 followed by actions taken 203 consequences 204 and links to subsequent decision points 205. The flow is shown in English but can be of any one or a mix of languages. The information recorded in the experience is stored in database 103a

Each experience entered by a person is given a system generated unique identifier 201d that is stored in the database 103a and can be used to retrieve this specific experience for editing purposes. Note that a person might record multiple experiences that start with the same decision point and for each of these experiences, there will be a separate unique identifier 201d.

As shown in FIG. 2 the various parts of the experience can be entered and edited in different times. For example, a person might enter a decision point 201, data points 202 and action 203 at one point in time and then a few months later enter the consequence 204 and even later enter the a link to the subsequent decision points 205. Another example is when a person would like to add a data point 202c to an experience, in which case he will update the data points 202 of the experience. In both cases, the person editing the experience will be able access the experience using the experience unique identifier 201d

In this implementation, the decision point 201 includes a defined list of decision points 201-L that the user can choose from when entering an experience. If the user cannot find an adequate entry in the list, he can define a new decision point entry that meets his needs. The reason to maintain a list 201-L is so that the system can later correlate multiple experiences entered by multiple people that used the same decision point. Each of the items in the decision points list 201-L can be translated to different languages while retaining its original meaning such that when people enter experiences in different languages for the same decision point item, the system will still be able to correlate between these experiences. For example, if a user in New York entered an experience that starts from the decision point item: “How do I help my kid get more friends in school” and a user in Israel entered an experience that starts from the decision point: [symbol] [symbol] [symbol] [symbol] [symbol] [symbol] which is a translation to Hebrew of the same decision point item then the system will be able to correlate both experiences as originating from the same decision point.

In addition to the decision point item list 201-L, the person entering a decision point can also optionally add a description 201a, the date for the decision point 201c and choose multiple choices from a list of tags 201b that are relevant for this experience. All these fields will be used as search and sorting criteria for people viewing the experiences.

Data points 202 are the next part of the information provided by the person entering the experience. There might be none or multiple data points 202 for the decision point. For example, for a decision point on “How to help my kid get more friends in school”, the person entering the experience might want to provide the country 202a, number of kids in the family 202c, school grade 202b and the related decision points that represent related experiences 202d.

The data points list can be pre-populated based on the popular data points used by other people that recorded an experience for the same decision point. Each recorded experience might have a different set of data points even if the experience is for the same decision point, since each person might consider different data points important for his own experience. The person recording the current experience can fill in the data points, delete from the list of the data points for the experience he is recording or add additional data points for this experience record. For each data point in the experience, if needs be, the person can add additional values for the data point. For example—if the “kids in family” 202c data point is a list of 1-7 and the person recording the experience has 8 kids, he can change the data point to include up to 8 kids

When adding additional data points to an experience, a person can choose from a list of existing data points or define a new data point and its values. There can be various types of data points such as a date, number, free text, a multiple choice data point where a user can choose multiple values, a single choice data point where a user can choose one value only and other common types.

Much like the decision points, having a defined data point list enables viewing, searching and correlating between experiences based on data points much easier. Like decision points, data points can also be translated to various languages and maintain the same identity across different languages.

The next step is for the person to record the actions 203 that were taken as a result of this decision point. In some scenarios, the actions 203 information will be entered or further edited some time after the decision point 201 has been entered. In this case, the person will locate the experience using the ID 201d that is determined by the system when entering the decision point 201. Until the person explicitly records an action for this decision point, the system assumes the state of: “no action taken”.

In this implementation, the actions 203 includes a defined list of action items 203-L that the user can choose one or more actions from. If the user cannot find an adequate entry in the list 203-L, he can define a new action item that meets his needs. The reason to maintain a list 203-L is so that the system can later correlate multiple actions entered by multiple people for a specific decision point or for multiple decision points. Much like decision points 201-L each of the items in the actions item list 203-L can be translated to different languages while retaining its original meaning such that when people enter actions in different languages the system will still be able to correlate between these actions.

In addition to the actions item list 203-L, the person entering actions can also optionally add a description 203a and the date for the actions 203b. All these fields will be used as search and sorting criteria for people viewing the experiences.

Whether actions were recorded or not the person can record the consequence 204 for this specific instance of the decision point. In some scenarios, the consequence information 204 will be entered or further edited some time after the decision point 201 has been entered. In this case, the person will locate the experience using the ID 201d that is determined by the system when entering the decision point 201.

In this implementation, the consequence 204 includes a defined list of results 204-L that the user can choose one from. If the user cannot find an adequate entry in the list 204-L, he can define a new result that meets his needs. The reason to maintain a list 204-L is so that the system can later correlate multiple results entered by multiple people for a specific decision point or for multiple decision points. Much like decision points 201-L, each of the items in the consequence result list 204-L can be translated to different languages while retaining its original meaning such that when people enter consequence results in different languages the system will still be able to correlate between these actions.

In addition to the consequence result list 204-L, the person entering the consequence can also optionally add a description 204a and the date for the realizing the consequence 204b. All these fields will be used as search and sorting criteria for people viewing the experiences.

Another important piece of information that the person can record is what other experiences resulted as a consequence of this experience. This is done by entering information about the subsequent decision points 205. In some scenarios, the information about the subsequent decision points 205 will be entered or further edited some time after the decision point 201 has been entered. In this case, the person will locate the experience using the ID 201d that is determined by the system when entering the decision point 201. The subsequent decision point information 205 is used for creating connections between experiences so that people that view an experience can see were different actions and consequences led people that entered the experiences

In this implementation, the links to subsequent decision points 205 includes a list of decision points 205-L that can contain references to a specific instance of a decision point 205-La or a generic reference to a decision point 205-Lb. To add subsequent decision points, the person clicks on the “add” button for the list 205-L and is presented with a list of his decision points as well as the general list of decision points available in the system. The person can choose to add a specific reference to a decision point that he entered or a reference to a general decision point. To remove a decision point from the list of subsequent decision points, the person can un-check the check-box by the decision point

In addition the person can click on “add experience” 205a to create a new experience that is automatically linked as a subsequent decision point.

FIG. 3 depicts an exemplary method for viewing experiences. In this example, the viewer uses categories 301a, 301b and 301c to browse a specific list of decision points 303 that fall into these categories. The viewer can further refine the list of decision points using the search box 302a and the date range 302b, 302c by updating the criteria and hitting the refresh button 302d.

The experience view is further composed of a list of decision points 303, data points for the various decision points 304, actions for the various decision points 305, consequences 306 and links to subsequent decision points 307

When the viewer selects a specific decision point in the decision point list 303, the relevant data points 304, actions 305, consequences 306 and links to subsequent experiences 307 are populated. In the example shown in FIG. 3, for the decision point “How do I help my child get more friends in school” there are multiple experiences and the aggregated view for these experiences include data points 304a, 304b, 304c, 304d, actions 305a-1, 305b-1 and 305c-1, list of descriptions for each action 305a-2, 305b-2, 305c-2 the relevant consequences 306a-1, 306b-1 and 306c-1, the list of descriptions for the consequences 306a-2, 306b-2, 306c-2 and the list of subsequent experiences 307a, 307b and 307c

In the example shown in FIG. 3, the viewer can further filter the information about the experiences by adding/deleting specific data points in the data points list 304 and selecting/deselecting various options within the data points (e.g.: 304a, 304b . . . ). For example: in the example, the School grade data point 304b has “Not specified”, 1^{st} and 3^{nd} grade selected. This filters the information to experience entries that include 1^{st} grade or 3^{rd} grade in the School grade data point as well as all the entries where the School grade was not specified. If the viewer has a child in 1^{st} grade and would like to view experiences that include only 1^{st} grade only, the viewer can deselect “Not specified” and 3^{rd} grade and thus further filter the actions 305, consequences 306 and links to subsequent experiences 307 in this view to match experiences that specifically included School grade that is 1^{st} grade. The viewer can reset the data point selection by pressing the “Show all” button 304s which will show all the relevant data points and selections for this experience.

The actions 305 include the action taken and additional descriptions entered by the author of the experiences. In the example shown in FIG. 3, there are three action groups 305a-1, 305b-1 and 305c-1. This means that for this decision point given the various applied filters, the aggregated experiences included three different groups of actions 305a-1, 305b-1 and 305c-1. For each group of actions there is a list of descriptions that were entered for this group of action. For example, if there are 10 different experiences that include the decision point “How do I help my child get more friends in school” and match the given data points and the action was “No action taken” (305a-1) then the description list 305a-2 will show the 10 descriptions entered for these 10 experiences. One thing to note is that the action group 305b-1 includes two actions. This reflects that there were people that for this specific decision point chose these two actions when entering their specific experience. As shown in FIG. 2, this can be done by selecting more than one action in the action list 203-L when entering an experience

The consequences 306 are the aggregated recorded consequences of the actions 305 for the decision point. For each of the action groups, the consequences indicate for each consequence what is the % for a consequence that happened for these actions and the descriptions that were entered for the consequences of this action group. In the example shown in FIG. 3, for the “No action taken” 305a-1, the consequences in the consequence list 306a-1 show that for 20% of the experiences people entered “No change”, for 5% people entered “Change for the worse”, for 10% people entered “Partial improvement” and for the rest 65% people entered “Issue resolved”. The list of descriptions 306a-2 includes further descriptions for the consequences in 306a-1. The descriptions that will be shown are the ones for the selected consequences in 306a-1, meaning that the descriptions shown are for “No change”, “Change for worse” and “Partial improvement”

The subsequent experiences 307 are the aggregated list of links to relevant experiences for the selected consequences 306 of the actions 305 for the decision point. For each of the action groups and consequences of this action group, the viewer can follow links to other experiences that resulted from these consequences. In the example shown in FIG. 3, for the “No action taken” 305a-1, and the selected consequence in the consequences list 306a-1, the list of links to subsequent experiences 307a includes links to “Should I volunteer in school” and “My kid is bullied in school”. Clicking on one of the links, leads the viewer to view the selected experience, maintaining the filters and data points from the current experience.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method for documentation of human experiences comprised of: an origin point of the experience, data points that relate to the experience, potential actions taken and the resulting consequences.

2. The method of claim 1, wherein the origin point, data points, actions and consequences are entered and edited at different points in time.

3. The method of claim 1, wherein the origin point of an experience is a decision that needs to be taken.

4. The method of claim 1, wherein there are zero or more data points for the experience that are of different types such as date (e.g.: Date of experience), number (e.g.: Age), alpha numeric (e.g.: Name), multiple choice (e.g.: Country) and other well known data types.

5. The method of claim 1, wherein there are zero or more actions taken

6. The method of claim 1, wherein there are zero or more resulting consequences taken

7. The method of claim 6, wherein a consequence can point to the origin point for another experience

8. The method of claim 1, wherein all the information is stored in a database and/or other electronic binary or text formats

9. The method of claim 1, further comprising having a predefined list of origin points, data points, potential actions and resulting consequences

10. The method of claim 9, where each of the predefined lists can be modified to add/remove/edit items from these lists

11. The method of claim 9, wherein in addition to the experience being comprised from the predefined list of items, the experience fields can also include additional descriptions

12. The method of claim 9, wherein the predefined lists and/or additional descriptions can be translated into different languages

13. A system for recording and viewing experiences comprising:
a user interface to record an experience by documenting a decision that a person needs to make, the relevant data points that relate to the decision, the actions taken and the consequences of these actions and
a user interface that allows people to link between experiences and to specify that the consequence of one experience is another experience and
a user interface to allow people to view and comment on other people's recorded experiences and
a database that stores all the experiences data

14. The system of claim 13, wherein multiple people can add and edit their personal experiences for a similar decision point.

15. The system of claim 13, wherein users that view a specific experience can filter the actions and consequences from multiple people that entered an experience according to data points

16. The system of claim 13, wherein users can search and navigate to various experiences based on a defined tag paths and search results for keywords
